(19) United States
(12) Patent Application Publication
(10) Pub. No.: US 2012/0008851 A1
(43) Pub. Date: Jan. 12, 2012

(54) Remote negotiable instrument processor

(76) Inventors: Sean Pennock, Royse City, TX (US); Eric Dotson, Rockwall, TX (US); Scott Harris, Rockwall, TX (US); Keith Reeves, Roswell, GA (US)

(21) Appl. No.: 12/803,975

(22) Filed: Jul. 12, 2010

(51) Int. Cl. G06K 9/00

(52) U.S. Cl. 382/140

(57) ABSTRACT

An electronic method and device are provided to facilitate the capture of Magnetic Ink Character Recognition (MICR) data information present on negotiable instruments. As an input device, a MICR reader capable of reading magnetic ink character recognition data is provided. As an output channel, an audio jack adapted to be plugged into an audio port of a mobile phone is provided. The device is attached to an audio port of a mobile phone. A negotiable instrument is swiped through the MICR reader. If the amount of the negotiable instrument is not included in the MICR data, the amount of the negotiable instrument is entered into the mobile phone. The MICR data and amount of the negotiable instrument are transmitted to create an electronic instrument.

### FIELD OF THE INVENTION

The present invention relates to processing of negotiable instruments.

### BACKGROUND OF THE INVENTION

Every day, business customers deposit thousands of paper checks in financial institutions by physical deposits. Business accounts need to make deposits quickly and conveniently. Rushing to a branch is usually a hassle, even if only blocks away. In addition, because of the delay in depositing paper checks, business owners get feedback on bad checks too late to let them stop shipping an order before it reaches the offending customer.

Bank checks first came into use in the late 1600s in England. Goldsmiths stored gold and silver for customers in exchange for Goldsmiths notes (also called a bill of exchange or draft). The customers could write an order to the Goldsmith to pay back a certain sum to the customer or to another person or the bearer of the note. Checks evolved from these bills of exchange. The derivation of the word ‘check’ is reported to have originated from the placing of a serial number to a bill of exchange or commercial paper as a means of verification allowing the bill of exchange to perform as a check does today.

In the United States, following the 1849 California gold rush the Wells Fargo Stage Coach Line specialized in shipping gold and silver from western mines to points east. When these shipments became subject to stage coach robberies, Wells Fargo eventually worked out correspondent relationships with eastern banks so that clearings of payments using drafts or checks eliminated the physical movement of large amounts of gold. Consequently, Wells Fargo also became a California state chartered bank.

By 1913, the United States had 48 states and the check had become an accepted form of payment. But as the volume of checks grew, a check deposited at a bank on one coast could take weeks to be paid. That year the Federal Reserve Act established the Federal Reserve System, often referred to as the Federal Reserve or simply “the Fed”.

The Federal Reserve System is the central bank of the United States. Congress created the Federal Reserve System to provide the nation with a safer, more flexible, and more stable monetary and financial system. The Federal Reserve System is basically composed of a central, governmental agency—the Board of Governors—and twelve regional Federal Reserve Banks, located in major cities throughout the nation. The seven members of the Board of Governors are nominated by the President of the United States and confirmed by the U.S. Senate.

The Fed member banks kept their reserves with their district Fed, which could pool them and extend credit to member banks under certain conditions. As a result, the clearing of checks with the nationwide Federal Reserve Bank clearing system shortened the clearing times and reduced excessive exchange charges for checks.

By 1952, there were 47 million checking accounts with 8 billion checks written annually. The average check passed through 2.3 banks and required 2.3 business days to be presented and collected. Therefore, on an average business day, there were 69 million checks in process throughout the payments system. These paper checks were manually handled and sorted based on the bank routing number in fraction form printed in the upper right hand area of the check. The sheer volume of paper was threatening to crush the banking system. In April 1954, the Bank Management Commission of the American Bankers Association formed a Technical Committee on Mechanization of Check Handling to study the problem and recommend a common machine language for the possible automation of the paper based payments system.

The Technical Committee began working with various machine manufacturers and over a period of two years studied carrier systems with the data encoded on a surface attached to or wrapped around the check, and non-carrier systems consisting of codes or patterns and Arabic characters readable by machine or by the human eye. The Technical Committee reviewed magnetic ink binary or bar codes with miniature bar codes on the reverse side of the check, fluorescent spot codes, and Arabic character systems, some using conventional printer's ink and others using magnetic inks.

In July 1956, the Technical Committee published Document 138, Magnetic Ink Character Recognition: The Common Machine Language for Check Handling. The committee recommended magnetic ink character recognition (MICR) based on the advantages of having a machine readable language which also was easily readable by humans; the relative insensitivity of the magnetic ink signals to mutilation, and a demonstrated feasibility. Following this, the major machine manufacturers, representatives of the printing industry, and the Federal Reserve System unanimously indicated their concurrence of MICR as the common machine language for mechanized check handling.

During the first OEM Committee meeting, in September 1956, Dr. Kenneth R. Eldredge of the Stanford Research Institute presented his work on magnetic character recognition on behalf of General Electric. Dr. Eldredge filed for a patent on Automatic Reading System on May 6, 1955 and was granted U.S. Pat. No. 3,000,000 on Sep. 12, 1961. Because of their early state of the art work in magnetic ink recognition, the Stanford Research Institute, the Bank of America, and GE were heavily involved in submitting and evaluating many of the fonts which were submitted to the Type Design Committee.

The next step was to determine the actual location and format of the fields of the common machine language. Areas adjacent and parallel to either the top or bottom edge of a check were considered. Reasons advanced in favor of the bottom edge were fewer mutilations, economy in equipment and operation, and greater customer acceptance. The one reason advanced in favor of the top edge was the apparent difficulty of adapting bottom edge encoding to punch card checks which were in common use. The preference ultimately was for the bottom edge. Compatibility with the 80 column punch card was reached with recognition that only the left most 50 columns could utilize the 9's punched hole positions as long as the pre-printed MICR information was positioned parallel and adjacent to the bottom edge of the punch card. Post printing or encoding for these checks would be at the same location designated for all other types of checks.

In April 1957, the Technical Committee on Mechanization of Check Handling published in Document 141 their recommendations on Placement for the Common Machine Language on Checks. In January 1958, the ABA Technical Committee released publication 142, Location and Arrangement of Magnetic Ink Characters for the Common Machine Language on Checks. This report covered the fields on items to be encoded, the number of digits allotted to each, and the sequence of the information.

In July 1958, A Progress Report: Mechanization of Check Handling published as Publication 146 specified the clear printing areas on the check and announced the field evaluation test for the E-13A type font. The Type Design Committee engaged Batelle Memorial Institute to administer the details of the trial printing and machine readability of the font. Battelle acted as a clearing house for instructions and received unidentified printing batches and forwarded them to machine companies for evaluation. The readability results were compiled by Battelle and presented in a report. Finally, in November 1958, the Type Design Committee agreed on a change in the Transit symbol and a relaxation of the void specification.

The “E” in the designation E-13B stands for the 5th letter of the alphabet, which signifies 5 numerical type fonts or styles of type that were studied starting with the letter A. The “13” means the 0.013 inch grid that constitutes the matrix of the font. Each character has segments which are multiples of the 0.013 inch grid. The “B” stands for a modification of the 5th type font: with the E-13A font, a problem was noted as the transit symbol was sometimes misread as a character 8; the transit symbol was changed and the type font was then designated as E-13B.

Concurrently with the font development, the problem of format was resolved, and in April 1959 the Bank Management Commission of the American Bankers Association published Document 147, The Common Machine Language for Mechanized Check Handling: Final Specifications and Guides to Implement the Program. In December 1959, the Bank Management Commission of ABA released Publication 149, which relaxed additional tolerances and provided clarification of others. These changes were incorporated into 147R, which was released in February 1962. Publication 147R was revised two more times with the release of Publication 147R3 in 1967.

The Standards Committee on Computers and Information Processing, X3, with the Business Equipment Manufacturers Association as Secretariat, recognized the desirability of issuing the E-13B work as an American National Standard. Thus, the Standards Committee formed the X3-7 Subcommittee on MICR and, with the assistance of the X3-7-1 technical group, issued 2 related standards on MICR in 1963 as ANSI X3.2-1963, American National Standard: Print Specifications for Magnetic Character Ink Character Recognition and ANSI X3.3-1963, American National Standard: Bank Check Specifications for Magnetic Ink Character Recognition. Much of the information presented in those first Standards was taken from Publication 147. Meanwhile, the X3 committee kept X3-7 active and endorsed X3-7′s participation in the International Organization for Standardization, Technical Committee 97, Subcommittee 3 (ISO/TC 97/SC3) on Character Recognition.

After a series of international meetings terminating in 1965, the ISO Recommendation R 1004-1969, Print Specification for Magnetic Character Recognition, was published. This recommendation contained the E-13B specifications in addition to another MICR character set known internationally as CMC-7. By 1968, the American Bankers Association deferred the publication of 147R3 and future revisions to the American National Institute, and both Standards X3.2 and X3.3 were revised again in 1970 and re-affirmed in 1976. In 1982, X3 assigned responsibility for the maintenance of X3.2-1970 and X3.3-1970 to its Subcommittee X3A1, Character Recognition. In 1983, X3A1 enlisted the assistance of American National Standards Committee, Financial Services - X9, and its Subcommittee, X9B (Paper Based Transactions), in order that a detailed review of X3.2-1970 and X3.3-1970 could be accomplished with input from all interested groups. In 1983, X3 approved transfer of X3.3 to X9 with the publication of X9.13-1983, American National Standard Specifications for Placement and Location of MICR Printing. In 1987, X3 approved the transfer of X3.2 to X9 and the revision of that publication became X9.27-1988, American National Standard for Magnetic Ink Character Recognition.

Meanwhile the ASC X9 Subcommittee, X9B, was growing because of a renewed interest in checks. Those who forecast the demise of checks in the 1980's as being replaced by electronic funds transfer were proven wrong as check volume continued to climb throughout the 1980's at 5-8% compounded annual growth rate. Membership in X9B continually increased as the following standards were developed: Specifications for Check Endorsements, X9.3; Bank Check Background and Convenience Amount Field, X9.7; Paper Specifications for Checks, X9.18; X9 Technical Guideline for Understanding and Designing Checks, X9/TG-2; Check Carrier Envelope Specification, X9.29; Legibility Specifications for Endorsements, X9.36; Extension Strip Specification, X9.40; X9 Technical Guideline: Quality Control of MICR Documents, X9/TG-6; and X9 Technical Guideline: Check Security Guidelines, X9/TG-8.

In 1995, ANSI X9.46, American National Standard for Financial Image Interchange: Architecture, Overview, and System Design Specification was introduced, which permitted electronic check presentment with image send or subsequent image store/forward systems and image query and retrieval on demand. This enabled financial institutions to reduce transportation costs of paper documents and improve the speed of return of unpaid items image check documents in order to improve customer service, automate proof-of-deposit functions, enable image reconciliation of in-clearings and provide image statements.

The process of removing the paper check from its processing flow is called truncation. In truncation, both sides of the paper check are scanned to produce digital images. If a paper document is still needed, these images are inserted into specially formatted documents containing a photo-reduced copy of the original checks called a “substitute check”. Once a check is truncated, businesses and banks can work with either the digital image or a print reproduction of the check. Images can be exchanged between member banks, savings and loans, credit unions, servicers, clearinghouses, and the Federal Reserve Bank.

At the item processing center, the checks are sorted by machine according to the routing/transit (RT) number as presented by the MICR line, and scanned to produce a digital image. A batch file is generated and sent to the Federal Reserve Bank or presentment point for settlement or image replacement. If a substitute check is needed, the transmitting bank is responsible for the cost of generating and transporting it from the presentment point to the Federal Reserve Bank or other corresponding bank.

In 2000 the Federal Reserve Board staff began investigating a concept of default check truncation rules that is now called the Check Clearing for the 21^{st} Century Act or “Check 21”. The goals of the Check 21 initiative were to enable a financial institution to substitute a machine-readable copy of a check for the original check for forward collection or return. These “substitute checks” are the legal and practical equivalent of the original check.

On Dec. 21, 2001, the Chairman of Board of Governors sent a legislative proposal to the Chairs and Ranking Members of the Senate and House Banking Committees. Both the House and Senate introduced bills in the 107^{th} Congress, and in the 108^{th} Congress the House introduced H.R. 1474 while the Senate introduced S. 1334. On Oct. 8, 2003 the Act passed House of Representatives unopposed. On Oct. 14, 2003, the Act was passed in the Senate by unanimous consent. President Bush signed the bill into law on Oct. 28, 2003. The effective date was 12 months after enactment, which was Oct. 28, 2004.

Check 21 also spawned a new bank treasury management product known as remote deposit. This process allows depositing customers the ability to capture front and rear images of checks along with their respective MICR data for those being deposited. This data is then uploaded to their depositing institution, and the customer's account is then credited. Remote deposit therefore precludes the need for merchants and other large depositors to travel to the bank (or branch) to physically make a deposit.

In addition to remote deposit, other such electronic depositing options are available to qualifying bank customers through NACHA-The Electronic Payments Association. These options include “Point of Purchase” (POP) for retailers and “Accounts Receivable Conversion” (ARC) for high volume remittance receivers. These transactions are not covered under the Check 21 legislation, but rather are electronic conversions of the checks MICR data into an ACH (Automated Clearing House) debit. This can help the depositor save on the costs of transporting checks and in bank fees.

Recently, Check 21 software providers have developed a “Virtual Check 21” system which allows online and offline merchants to create and submit demand draft documents to the bank of deposit. This process which combines remotely created checks (RCC) and Check 21 X9.37 files enables merchants to benefit from direct merchant-to-bank relationships, lower NSFs, and lower chargebacks.

However, left out in the cold are field-based personnel (for example, merchants or service people that typically work out of their vehicle). Today, the process is very problematic for field-based personnel, as there are no adequate solutions available. Currently, field-based personnel have limited options for processing payments made to them via check. Many of the current remote deposit products rely on images of the checks or force the field-based personnel to carry a large scanner and laptop computer with them.

The picture-based solution is the cheaper and more convenient of the two options currently available, but has a number of associated drawbacks. To use this solution correctly, the field-based user is required to take an image of the check using their cell-phone. That image is then sent to a server-based application that uses some sort of optical character recognition (OCR) technology to attempt to read the information from the check. In order to capture a usable image, the field-based user must be able to find a location with the proper lighting and a flat space to position the check properly to avoid capturing an image that is either too dark/too light or too skewed to be read correctly by the server-based application.

The other option, carrying a laptop computer with a large check image scanner, is also problematic. It is much more expensive, because each field-based user must be equipped with a laptop and scanner, so the equipment costs alone can be in the thousands of dollars, not including the software required to run each device. The image and data captured from the check are typically better quality and are more reliable than the data captured from a picture, but the solution is very clumsy to use while on the road. For example, finding a reliable power source for the scanner is an issue, because most field-based personnel operate out of the vehicles and do not have any way to provide the power needed to operate the scanner.

What would thus be desirable would be a system by which field-based personnel could easily deposit checks received from the customers into the appropriate bank account without being encumbered by hardware, software or processes that cause them to capture the check information incorrectly; take too much time setting up the required equipment or is prohibitively expensive. Most of these field-based personnel work for small businesses, and require quick access to the accounts receivable monies to operate in a positive cash-flow fashion.

### SUMMARY OF THE INVENTION

A small portable electronic device in accordance with the principles of the present invention enables field-based personnel to easily deposit checks received from customers into the appropriate bank account, without being encumbered by hardware, software or processes that cause them to capture the check information incorrectly; take too much time setting up the required equipment or are prohibitively expensive. In accordance with the principles of the present invention, an electronic method and device are provided to facilitate the capture of Magnetic Ink Character Recognition (MICR) data information present on negotiable instruments. As an input device, a MICR reader capable of reading magnetic ink character recognition data is provided. As an output channel, an audio jack adapted to be plugged into an audio port of a mobile phone is provided. The device is attached to an audio port of a mobile phone. A negotiable instrument is swiped through the MICR reader. If the amount of the negotiable instrument is not included in the MICR data, the amount of the negotiable instrument is entered into the mobile phone. The MICR data and amount of the negotiable instrument are transmitted to create an electronic transaction.

### BRIEF DESCRIPTION OF THE DRAWINGS

FIG. 1 is a perspective view an example device in accordance with the principles of the present invention with a mobile phone with side audio jack.

FIG. 2 is an overhead view of the example device of FIG. 1 with a mobile phone with top audio jack.

FIG. 3 is an overhead view of the example device of Figure a mobile phone with side audio jack cell phone and negotiable instrument.

FIG. 4 is a schematic of the example device of FIG. 1 showing the internal components.

FIG. 5 is a flow-chart showing a process that can be utilized to use the example device of FIG. 1 to capture the magnetic ink character recognition data from a negotiable instrument.

### DETAILED DESCRIPTION OF A PREFERRED EMBODIMENT

In accordance with the principles of the present invention, a small portable electronic device is provided that is adapted to be attached to mobile phones to facilitate the capture of Magnetic Ink Character Recognition (MICR) data information present on negotiable instruments (usually checks) for the purpose of utilizing this captured information to create an electronic instrument.

Although the specific size dimensions of the device is not a limitation herein, example dimensions are helpful in understanding the portable nature of the present invention. In one embodiment in accordance with the principles of the present invention, the device itself can be approximately 0.5-0.75 inches wide with a length of approximately 1.5-3.0 inches and a height of approximately 0.75-1.0 inches.

A device in accordance with the present invention can be connected to mobile phones through the standard audio port found on the vast majority of mobile phones. Negotiable instruments can then be swiped through the device to capture the MICR information and provide this information to an application which can reside on the mobile phone. The MICR information consists of financial institution routing number, customer account number, serial (check) number, and any other information present. The required information will be provided to the application which will continue processing the transaction.

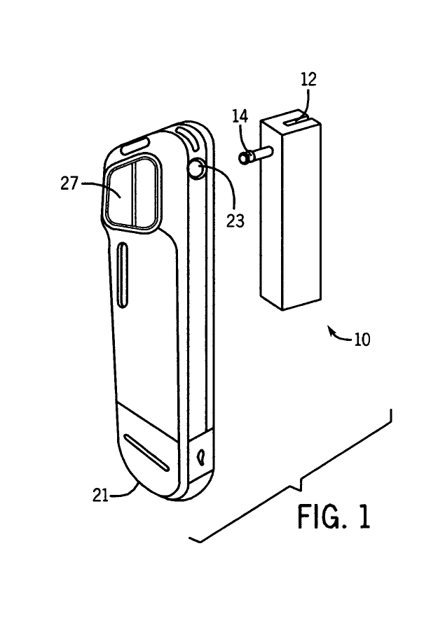

Referring to FIG. 1, a perspective view is seen of an example device in accordance with the present invention with a mobile phone with side audio jack. The example device 10 is adapted to be used with a standard cellular phone 21 mobile phone. Of course, while the mobile phone described herein is a cellular phone, the invention is by no means intended to be limited thereby. The device 10 includes as an input device a MICR reader 12 and as an output channel an audio jack 14. The MICR reader 12 is capable of reading magnetic ink character recognition data, in this example the E-13B MICR font used on U.S. checks today. The audio jack 14 can be plugged into the audio port 23 currently in use as the standard on almost all cellular phones 21.

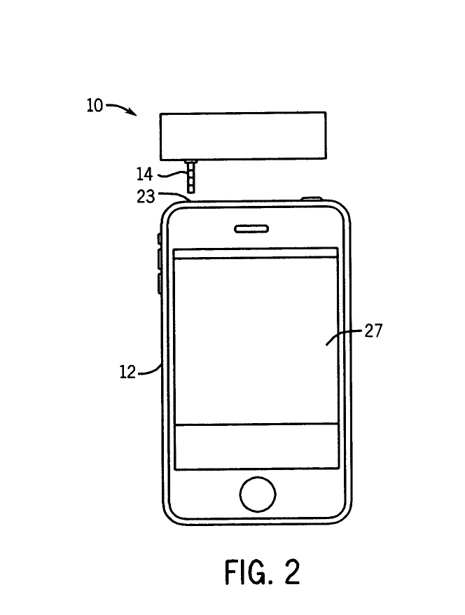

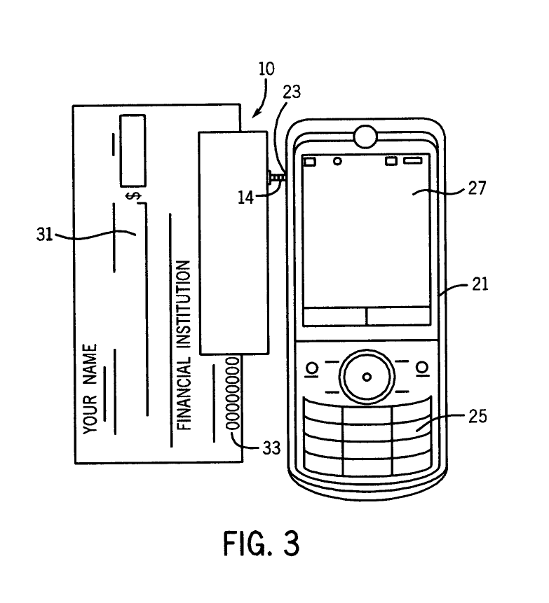

An internal processor is provided that handles communication between the input device and the output channel connected to the cellular phone 21. An application is downloaded into the cellular phone, and the user can interact with the application through the cellular phone 21, such as by use of the keypad 25 (an example of which is seen in FIG. 3) and display 27. The present invention can be used with any cellular phones with a standard audio jack, regardless of where the audio jack is located on the phone. Thus, referring to FIG. 2, an overhead view of the example device 10 of FIG. 1 is seen with a cell phone 21 with top audio jack 23.

Power required by the device 10 can be supplied through the audio jack 14 through the audio port 23. The present invention need contain no gears or other mechanical components, so the power requirements are low since the MICR reader and the processor are the only components that consume power to operate. Because power required by the device can be supplied through the audio jack, it does not require an internal or external power source. The present invention is intended to remain attached to the phone only while it is in use, and can be removed when it is not in use. When attached, the present invention will not disrupt other operations of the phone. If left attached to the phone, the present invention can go into a standby or “sleep” mode to avoid needlessly draining the power from the battery of the cell phone. The present invention can “wake up” when the application is running on the cell phone and/or when a check is scanned.

Referring to FIG. 3, an overhead view of the example device 10 of FIG. 1 is seen with a cellular phone 21 with side audio jack 23 and negotiable instrument 31. The MICR 33 can be seen in part near the bottom of the negotiable instrument 31. In a preferred embodiment, the negotiable instrument can be swiped in either direction through the MICR reader 12, allowing the user to easily use the device 10 in any configuration with either hand.

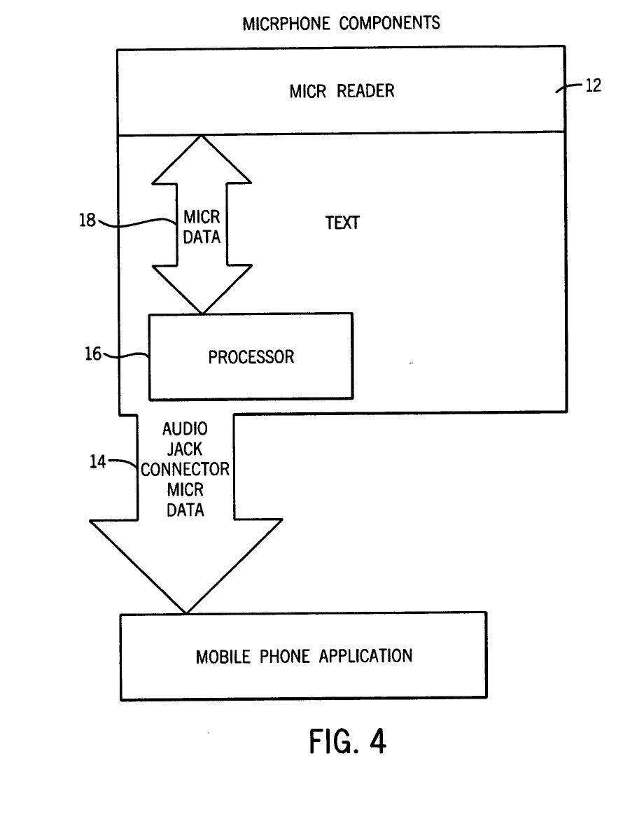

Referring to FIG. 4, a schematic of the example device of FIG. 1 is seen showing the internal components. Again, the device 10 includes as an input device a MICR reader 12 and as an output channel an audio jack 14. Power can be supplied through the audio jack 14 through the audio port 23. An internal processor 16 is provided that handles communication between the input device and the output channel connected to the cellular phone 21. The MICR reader 12, the audio jack 14, and internal processor 16 are in communication with each other via data busses.

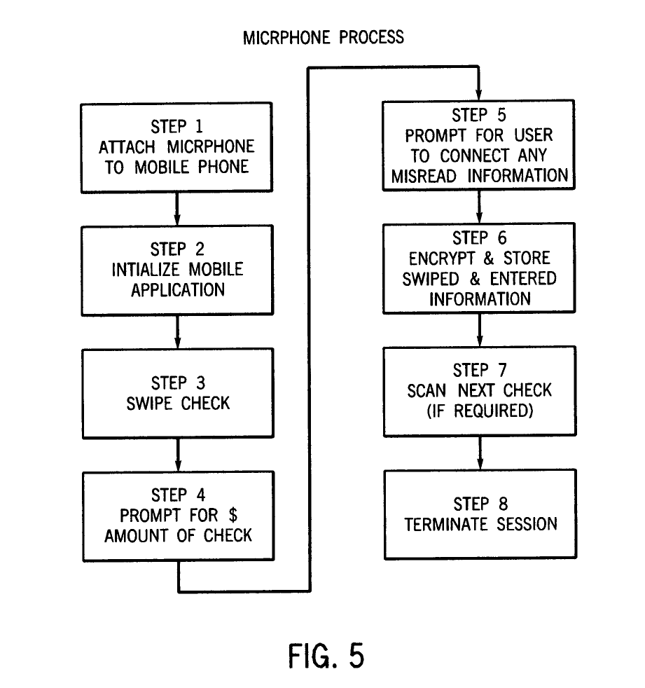

Referring to FIG. 5, a flow-chart is seen showing a process that can be utilized to use the example device of FIG. 1 to capture the MIRCR data from a negotiable instrument. Initially, the device is attached (A) to the mobile phone. To start the process of the present invention, the user plugs device into the audio port of a mobile phone. Examples of suitable operating system for the cellular phone include Symbian platform administered by the Symbian Foundation Limited, 1 Boundary Row, Southwark, London, SE1 8HP, U.K.; iPhone OS from Apple Inc., 1 Infinite Loop, Cupertino, Calif. 95014; Palm WebOS from Palm, Inc., 950 West Maude Avenue, Sunnyvale, Calif. 94085; BlackBerry OS from Research In Motion Limited, 295 Phillip Street, Waterloo, Ontario Canada N2L 3W8; Windows Mobile from Microsoft Corporation, 4200 150th Avenue N.E., Redmond, Wash. 98052; and Android from Google Inc., 1600 Amphitheatre Pkwy, Mountain View, Calif. 94043.

Next, the mobile application is initialized (B). After the device has been plugged into the mobile phone, the user starts the application running on the mobile phone, and the application asks the user for credentials before beginning the session. When the user enters the correct credentials on for example the keypad, the application starts a local session (i.e. no connection has yet been made with a server) and connects to the device 10, so that transmission of data can begin.

Next, the negotiable instrument is swiped (C). When the local session has successfully started, the application asks the user to swipe the negotiable instrument through the MICR reader. Again, FIG. 3 shows an example of how a check 31 is swiped through the MICR reader. After the negotiable instrument has been swiped, the application accepts and parses the MICR information consisting of financial institution routing number, customer account number, serial (check) number, and any other information present into the following data elements: AuxOnus, serial number, routing transit, account number, and amount (if included in the MICR line).

Next, the amount of the negotiable instrument is entered (D). If the amount of the negotiable instrument is not included in the MICR information (as will be the case for the majority of negotiable instrument), the application prompts the user to enter the amount (in dollars and cents) of the negotiable instrument. The application displays the amount being entered on a user interface such as for example through a cellular phone display 27, so the user can visually verify that the correct amount is entered.

Next, the user can correct any misread information (E). The application validates the MICR information, and asks the user to correct any information containing either misread characters or characters that could not be read. The application includes a user interface such as for example through a cellular phone display 27 showing where to find the information on the negotiable instrument and also showing the characters being entered, so the user can verify that that correct information is entered.

Next, the data is encrypted and prepared for transmittal (F). After the negotiable instrument has been entered, and all of the information has been corrected as needed, the application encrypts the data and prepares it for transmittal. Depending on the server application in use, the information may be transmitted immediately or “batched” together with other negotiable instrument information for transmittal at the appropriate time.

Next, the system prepares to scan another negotiable instrument (G). The application asks the user whether there is another negotiable instrument to be scanned. If the answer is yes, then the process starts over at Step 3; if the answer is no, then the process moves to the next step.

The next step is to terminate the session (H). After all negotiable instrument have been scanned, and all necessary data has been entered and prepared for transmission, the session is terminated and the device 10 can be removed from the mobile phone.

Thus, a device in accordance with the present invention is designed to be plugged into the standard audio port found on most of today's smart phones manufactured and marketed throughout the world. The technology used to design and manufacture the audio jack does not vary significantly from manufacturer to manufacturer, so the present invention essentially acts as a universal device for any smart phone with a standard audio jack.

It should be understood that various changes and modifications preferred in to the embodiment described herein would be apparent to those skilled in the art. Such changes and modifications can be made without departing from the spirit and scope of the present invention and without demising its attendant advantages. It is therefore intended that such changes and modifications be covered by the appended claims.

What is claimed is:

1. An electronic device to facilitate the capture of Magnetic Ink Character Recognition (MICR) data information present on negotiable instruments comprising:
as an input device, a MICR reader capable of reading magnetic ink character recognition data;
as an output channel, an audio jack adapted to be plugged into an audio port of a mobile phone;
whereby the captured MICR data can be utilized to create an electronic instrument.

2. The electronic device to facilitate the capture of Magnetic Ink Character Recognition (MICR) data information present on negotiable instruments of claim 1 further comprising as an input device, a MICR reader capable of reading E-13B MICR font .

3. The electronic device to facilitate the capture of Magnetic Ink Character Recognition (MICR) data information present on negotiable instruments of claim 1 further comprising a processor to communicate between the input device and the output channel.

4. The electronic device to facilitate the capture of Magnetic Ink Character Recognition (MICR) data information present on negotiable instruments of claim 1 further comprising an application to be downloaded into the mobile phone to utilize the captured MICR data to create an electronic instrument.

5. The electronic device to facilitate the capture of Magnetic Ink Character Recognition (MICR) data information present on negotiable instruments of claim 1 further wherein power is supplied through the audio jack through the audio port , thus further comprising the absence of internal or external power source.

6. The electronic device to facilitate the capture of Magnetic Ink Character Recognition (MICR) data information present on negotiable instruments of claim 1 further wherein the dimensions of the device is approximately 0.5-0.75 inches wide, approximately 1.5-3.0 inches in length, and approximately 0.75-1.0 inches in height.

7. A method of capturing Magnetic Ink Character Recognition (MICR) data information present on negotiable instruments comprising:
attaching a device to an audio port of a mobile phone, the device having a MICR reader capable of reading magnetic ink character recognition data;
swiping a negotiable instrument through the MICR reader;
if the amount of the negotiable instrument is not included in the MICR data, entering into the mobile phone the amount of the negotiable instrument;
allowing a user to correct information; and
transmitting the MICR data and amount of the negotiable instrument.

8. The method of capturing Magnetic Ink Character Recognition (MICR) data information present on negotiable instruments of claim 7 further including, after the device has been attached to an audio port of a mobile phone, requiring user credentials.

9. The method of capturing Magnetic Ink Character Recognition (MICR) data information present on negotiable instruments of claim 7 further including displaying the amount being entered on a user interface.

10. The method of capturing Magnetic Ink Character Recognition (MICR) data information present on negotiable instruments of claim 7 further including allowing a user to correct information containing either misread characters or characters that could not be read.

11. The method of capturing Magnetic Ink Character Recognition (MICR) data information present on negotiable instruments of claim 7 further including encrypting the MICR data.

12. The method of capturing Magnetic Ink Character Recognition (MICR) data information present on negotiable instruments of claim 7 further including “batching” together the MICR data and amount of the negotiable instrument with other negotiable instrument information for transmittal.
